(19) United States
(12) Patent Application Publication
(10) Pub. No.: US 2011/0061300 A1
(43) Pub. Date: Mar. 17, 2011

(54) Energy-saving vertical valance assembly

(76) Inventors: Eddie L. Fisher, Richton Park, IL (US); Don F. Moyer, Chicago, IL (US)

(21) Appl. No.: 12/586,114

(22) Filed: Sep. 17, 2009

(51) Int. Cl. E06B 7/28; E06B 3/30

(52) U.S. Cl. 49/70; 160/90

(57) ABSTRACT

The energy-saving vertical valance assembly has a panel which overlaps gaps at edges of a drawn window shade and has a mounting grip, the panel having a mounting leg which is held against the window by the grip, the assembly reducing energy exchange between indoors and outdoors by reducing air circulation at the gaps and reducing radiation and conduction energy exchanges at parts of the window the panel is held against.

The vertical valence assembly reduces energy exchange between indoors and outdoors because of combination of the way it is attached to window frames with properties of the valance material. This energy-saving function was unexpectedly discovered while exploring ways to attach, and materials for, a vertical valance assembly conceived to merely cover gaps at edges of drawn window shades.

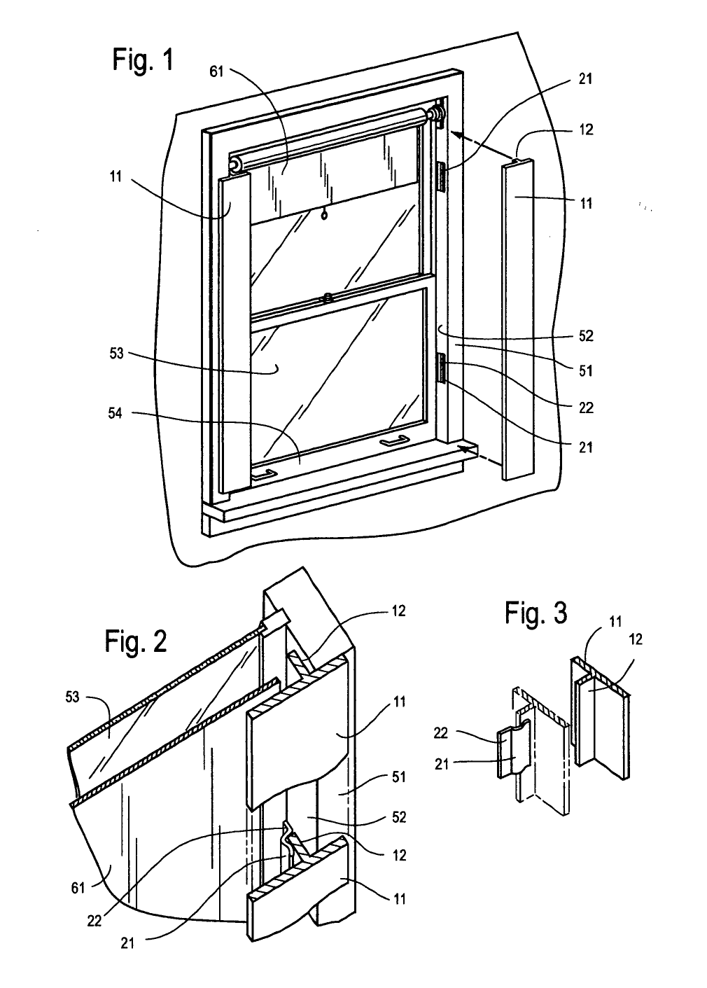

FIG. 1 shows the vertical valance assembly on a window.

FIG. 2 is an enlarged view of FIG. 1.

FIG. 3 is a side view of a valance mounting grip and vertical valance panel.

The window shown in FIG. 1 and FIG. 2 has a window casing 51, a window stop 52, a window pane 53, a window stile 54, and a window shade 61. When the window shade 61 is drawn, gaps are present along edges of the window shade 61. The panel covers these gaps, reducing air circulation at these gaps, thus reducing energy exchange between indoors and outdoors.

The vertical valance assembly includes a vertical valance panel and a valance mounting grip. When mounted on a window, the panel 11 extends from the window casing 51 towards the window pane 53. The panel 11 can overlap the window casing 51. The panel 11 can have a mounting leg 12, which extends away from the panel 11 towards- the window stop 52.

The valance mounting grip also depicted in FIG. 3 includes a clip 21 and a support 22. The valance mounting grip can be secured on the window stop 52 by the support 22 of the valance mounting grip. The clip 21 of the valance mounting grip can engage with the mounting leg 12 of the vertical valance, thus securing the panel 11 of the vertical valance against the window stop 52.

The panel extends over the gap at drawn shade edges. The panel can also extend over this gap and extend over part of the window casing. The panel can also extend over this gap and have the mounting leg extending over part of the window stop. The panel can extend over the gap, extend over part of the window casing, and have the mounting leg extending over part of the window stop. In all and each of these four options the panel can be attached to the window by various fasteners including adhesives and by various fastening assemblies.

Attaching the panel with the mounting clip as shown in the figures holds the panel against parts of the window stop and the window casing. Thus, when the panel is made of a material having a higher R-value than the parts of the window stop and window casing contacted by the panel, the panel reduces radiation and conduction energy exchanges between indoors and outdoors. When the panel is made of a flexible and contour-fitting and easily trimmed material this improves the contact and improves the reduction of energy exchanges.

The vertical valance assembly comprises a panel mounted on a window, the window having a window pane, a window casing, and a window stop. The panel extends towards the window pane to overlap portions of the window pane proximal the window stop not covered by a drawn window shade.

The panel can also overlap a portion of the window casing. The a panel can have a mounting leg along the panel and extending substantially orthogonally to the panel to overlap the window stop. The mounting leg can be secured to the window stop.

The assembly can also comprise a mounting grip having a support and a clip. The support is for securing the mounting grip to the window stop, and the clip is for securing the panel against the window stop.

The panel can be made of a material with higher R-value than materials of the window stop and the window casing. The panel can be made of a flexible, and contour-fitting material.

Claimed is:

1. A vertical valance assembly comprising:
a panel mounted on a window, the window having a window pane, a window casing, and a window stop,
the panel extending towards the window pane to overlap portions of the window pane proximal the window stop not covered by a drawn window shade.

2. The assembly of claim 1 wherein the panel also overlaps a portion of the window casing.

3. The assembly of claim 1 wherein the panel has a mounting leg along the panel and extending substantially orthogonally to the panel to overlap a portion the window stop.

4. The assembly of claim 2 wherein the panel has a mounting leg along the panel and extending substantially orthogonally to the panel to overlap a portion the window stop.

5. The assembly of 4 wherein the mounting leg is secured to the window stop.

6. The assembly of claim 5 further comprising:
a mounting grip having a support and a clip,
the support for securing the mounting grip to the window stop, and
the clip for securing the panel against the window stop.

7. The assembly of claim 6 wherein the panel is made of a material with higher R-value than materials of the window stop and the window casing.

8. The assembly of claim 7 wherein the panel is made of a flexible, and contour-fitting material.

9. A vertical valance assembly comprising:
a panel mounted on a window, the window having a window pane, a window casing, and a window stop,
the panel extending towards the window pane to overlap portions of the window pane proximal the window stop not covered by a drawn window shade,
the panel also overlapping a portion of the window casing,
the panel having a mounting leg along the panel and extending substantially orthogonally to the panel overlapping a portion the window stop; and
a mounting grip having a support and a clip,
the support for securing the mounting grip to the window stop, and
the clip for securing the panel against the window stop.

10. The assembly of claim 9 wherein the panel is made of a material with higher R-value than materials of the window stop and the window casing.

11. The assembly of claim 9 wherein the panel is made of a flexible, and contour-fitting material.

12. A vertical valance assembly comprising:
a panel mounted on a window, the window having a window pane, a window casing, and a window stop,
the panel extending towards the window pane to overlap portions of the window pane proximal the window stop not covered by a drawn window shade,
the panel also overlapping a portion of the window casing,
the panel having a mounting leg along the panel and extending substantially orthogonally to the panel overlapping a portion the window stop,
the panel being made of a material with higher R-value than materials of the window pane and the window casing, and
the panel being made of a flexible, and contour-fitting material; and
a mounting grip having a support and a clip,
the support for securing the mounting grip to the window stop, and
the clip for securing the panel against the window stop.
